(19) United States
(12) Patent Application Publication
(10) Pub. No.: US 2002/0009184 A1
(43) Pub. Date: Jan. 24, 2002

(54) CALL CLASSIFICATION INDICATION USING SONIC MEANS

(76) Inventor: J. MITCHELL SHNIER, TORONTO (CA)

Correspondence Address: J MITCHELL SHNIER, 25 LOWER LINKS ROAD, TORONTO, M2P1H5, CA

(21) Appl. No.: 09/422,956

(22) Filed: Oct. 22, 1999

(51) Int. Cl. H04M 1/56; H04M 15/06

(52) U.S. Cl. 379/142.01; 379/142.09; 379/252

(57) ABSTRACT

A sonic method of classifying and screening incoming telephone, and other types of calls is disclosed. Based on information from the network provider, such as a caller ID message from a telephone company, distinctive sounds which are easy to mentally associate with specific callers or categories of callers are generated in place of, or in addition to, other call alerting methods, such as the standard ringing of telephones—so there is no need to go to, view, or to be able to read, the caller ID information on a visual display. The invention can be configured to not generate a distinctive sound for certain callers or categories of callers, so calls from certain callers or categories of callers will not disturb the called party. The invention can be connected to any telephone receptacle as a standard telephone or answering machine would be, so no special wiring or installation is required.

An important feature is the handling of calls where the caller ID message contains an unrecognized directory number, or no directory number, and the detection of calls from such repeat callers when they call back within a specific timing window. A distinctive sound can be assigned to such repeat callers. Therefore, categories of calls that do not cause the invention to generate a distinctive sound on the first call attempt, will generate a distinctive sound for repeat call attempts. This allows certain callers to “break through” this call screening. Also, the invention can copy its programming to other units, so a plurality of identically programmed units can be distributed throughout a household, to facilitate hearing them at any location.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to a method and apparatus for classifying calls, such as telephone calls. More particularly, a method for identifying callers or categories of callers by generating distinctive sounds in place of, or in addition to, the standard ringing of a telephone or other communications device. The distinctive sounds used are ones which are easy to mentally associate with specific callers or categories of callers. Significantly, the invention can optionally not generate a distinctive sound for telephone calls from specified callers and categories of callers, but can subsequently indicate if those ignored callers call back according to certain timing conditions. This allows certain repeat callers to “break through” this call screening.

Telephone companies now offer services which identify the telephone number (which is formally called the “directory number”) and optionally the directory name associated with a caller, as a digital message sent to the called location. This message is typically sent;

between the first and second rings on analog telephone lines, and

along with the call establishment signalling for digital telephone lines, such as for those using integrated services digital network (ISDN), or for digital trunks, such as those using common channel signalling such as signalling system number 7 (ss7).

Delivering the caller's directory number to the called party is variously called automatic number identification (ANI), calling number delivery (CND) and caller identification (caller ID), and the received information is typically displayed to called parties on a liquid crystal display (LCD) screen built-in to the telephone or on a small stand-alone adjunct unit (U.S. Pat. No. 4,582,956 to Doughty and U.S. Pat. No. 4,924,496 to Figa et al., for example). This widely-used caller ID display method has the deficiency that the display must be viewed to determine the identity of the caller. In a household with several people sharing a telephone line, somebody has to go look at the display, hopefully recognize the caller's number (a considerable problem in a household with several members) or name (also a problem, since the name is the directory name for the caller's household or business according to the telephone company records, not necessarily the name of the actual person that typically calls this particular called party), and decide whether to, how to, or who else should, and whether they are available to, answer the telephone. It would be a useful improvement if all people at the called location could simultaneously determine the identity of the caller using an easy to mentally associate sonic indication, so only the specific intended called person need go to, and answer, the telephone.

Another major deficiency of the above traditional caller ID display units is that they cannot screen out unwanted calls—that is, the telephone rings for every call, even if the call is from a mis-programmed fax broadcast service and intended for a facsimile machine, is from someone who dialed a wrong number, or is from a telemarketing organization or other calling party that the called party need not be bothered by.

Prior art has proposed several methods to address these problems.

U.S. Pat. No. 4,894,861 to Fujioka, U.S. Pat. No. 5,394,445 to Ball et al., and U.S. Pat. No. 5,481,594 to Shen et al. use digitized or synthesized speech output to announce the phone number or identity of the caller. These techniques enable all parties at the called location to hear the caller's identity as spoken words. However, a problem with this prior art includes either requiring the advance recording of the speech announcement to be made by the unit for each caller (which is a substantial task if it is to produce desirable results and if there are many names to be announced) or being able to comprehend a text-to-speech synthesizer's output when it is speaking people's names (which an especially difficult problem, given the plethora of pronunciation rules for foreign names, and abbreviations used for company names) or numbers (where listening to the area code before each number wastes time and one's patience—especially so now that many larger cities have mandatory 10-digit dialing, so the area code needs to be announced as well). Another problem is that usually, the spoken message will overlap with the ringing times of the telephones, increasing the difficulty of clearly hearing and comprehending the announcement. Another problem is the difficulty of duplicating this programmed information (such as digitized speech) on multiple units, which would be required to hear the announcement throughout a larger called party's home, for example. Also, some of these techniques make the announcement only once so it may be missed if not heard clearly the first time. Finally, the technique does not provide call screening, so even unwanted or unrecognized callers are announced.

U.S. Pat. No. 5,452,346 to Miyamoto also announces the caller's name using digitized speech, but can also use a special ring for pre-programmed recognized callers. It also repeats this output in place of the second and subsequent rings, solving the problem of missing a single announcement. The special ring sounds are produced only during the reception of the power ring signal from the telephone company, so hearing these in the presence of other standard telephone's ringing (in the same household, for example) would be difficult. Also, there is no provision to handle the very common case of the received caller ID message not containing the caller's directory number. Additionally, only an embodiment as a telephone set is disclosed, and the only audible alerting is to use either digitized speech to announce callers (which is burdensome to enter and to duplicate on multiple units) or to alter a telephone's standard ring to a different ring sound tone (which is difficult for called parties to remember for the identification of many unique callers). Finally, no call screening is provided, so all calls cause the telephone to generate ring sounds or speech output.

U.S. Pat. No. 5,388,150 to Schnayer et al. allows call screening by maintaining a database of recognized callers and using speech output or different alert signals to identify those callers to the called party. Also, call screening is provided by allowing programming so the unit does not ring for certain callers. One substantial shortcoming with the system is the handling of unrecognized callers: for such calls the unit can only be programmed to either always ring the telephone (therefore not providing call screening) or to always suppress ringing (therefore, not allowing a way for unrecognized callers to “break through” the call screening for important calls or when they are sure they have called the correct number after hearing the called party's answering machine's greeting). Another problem is the handling of the typically substantial percentage of calls that arrive without the caller's directory number in the caller ID message (there are a variety of reasons for this occurring, as described below). The technique used by Schnayer involves having the unit answer the telephone call and prompt the caller to provide further identifying information. This requires the system to have digitized speech recording and output capabilities, which is both expensive and the recorded messages are difficult to copy to other units, as might be required in a typical household. This also precludes the use of a standard answering machine, since the call has already been answered by the device, so a standard answering machine cannot be triggered. Also, the system disclosed requires complex programming and would be expensive as it has the full functionality of a telephone with LCD display, and well as interfaces for facsimile and answering machines. Installing multiple units so the ring sounds can be heard throughout a household would likely be prohibitively expensive. And while the disclosed “distant extension alert generators,” using the building's power cabling to communicate with them are also disclosed, using such a communication method has been shown to be unreliable (due to interference with electrical noise on the power lines), and installing separate wiring for these would be difficult.

U.S. Pat. No. 5,526,406 to Luneau describes a method of using speech to announce the calling party's identity through the called party's telephone earpieces, before the call is accepted (that is, before the off-hook signal is presented to the telephone company). This requires the called party to listen to a telephone handset, and to remember the method described to accept the call (if so desired, since lifting the telephone handset no longer answers the call). Further, in the case of a household, either all members need to go to a unit and pick-up the handset at the appropriate time to hear the announcement, or someone who does go to and pick-up a handset then has to decide how to handle calls intended for another member of the household, which requires all members of a household to be familiar with the identifying information for all other members' callers, and to know or quickly determine if those other members are available to take the call. Also, the announcement of the caller's identity is made only once, which may not be adequate. Also, as for the other prior art speech output announcing devices above, the apparatus requires much advance recording of the identification announcements for all expected callers, or called parties being able to comprehend synthesized speech of caller's names. While only one unit is required for an entire household, having to go to a telephone to hear the announcement is inconvenient. Finally, and importantly, the house wiring must be changed so that the unit can be installed between the incoming telephone line and the called party's telephones. This is difficult for most consumers, and worse than that, if the unit fails then all the telephones in the household could stop working until the apparatus can be removed or repaired.

U.S. Pat. No. 5,481,599 to MacAllister et al. discloses a telephone ringer that can provide any sound in place of a standard telephone ringer. However, the same ringing sound is used for all calls (that is, it does not support caller ID), so there is no way to identify specific callers by the ringing sound, and call screening is not provided.

U.S. Pat. No. 5,559,860 to Mizikovsky discloses a call screening method for cellular telephones. A priority caller ringing sound, long distance call ringing sound, muted (that is, no) ringing sound for undesired callers, and also a transmitted audio message to identify calls is disclosed. However, there is no way to allow certain ignored callers to “break through” and cause a ringing sound. Also, the method disclosed is only for a cellular telephone network. Finally, the matching of callers to the ring sound is only described as a central network function, rather than a called party premises equipment function.

In addition to the prior art described above, telephone companies typically offer services (typically each for an additional monthly cost) which can provide some level of caller identification and screening. These are each described below:

Caller ID with name display, where the name of the calling party (according to telephone company records) is displayed on an LCD screen on a telephone set or small adjunct box at the called party's premises. This service requires the called party to go to the display to view it, to be able to read the display, and to quickly decide how to handle the call—which is a problem when the call is for other members of a household and the call information is not recognized by all members of a household. Also, call screening is not provided.

Distinctive ringing, where more than one directory number is assigned to a single telephone line, and calling each directory number results in the called party's telephone ringing with a unique ringing cadence (such as ring-ring, pause, ring-ring, pause, and so on, rather than the typical ring cadence of ring, pause, ring, pause, and so on). The called party could then give out different directory numbers to different callers or categories of callers, so the called party can know who is calling by just listening to the ring cadence. However, the number of different ringing cadences available is typically limited to four, so only four callers or categories of callers can be identified by listening to the ring cadence. Also, remembering which caller uses which ringing cadence turns out to be very difficult for humans. A major problem is that the callers (and not the called parties) have control over which ring cadence the called party hears, since the caller can dial any of the called party's directory numbers—so the called party cannot be sure who is actually calling, just what number the caller dialed. Finally, call screening is not provided, as all callers cause the called party's telephone to ring.

Call Screening, which prevents callers with specific directory numbers from calling a subscriber's directory number. Such callers are instead redirected to a telephone company provided message saying the call will not be completed. Unfortunately, this service is typically limited to a small number of caller directory numbers, such as 12, which will not be enough for many potential subscribers. Also, calls from many types of callers (such as those from older cellular telephone systems or areas that do not support caller ID) cannot be screened-out, since the calling network does not identify the caller's directory number. Additionally, new callers, and screened-out callers calling from a different phone (such as a pay phone), will not be screened-out. Also, telephone company based call screening typically cannot be automatically changed based on a daily schedule, and cannot be temporarily overridden.

Privacy Manager, which first prompts new callers whose directory numbers will not appear in the caller ID message (perhaps because the caller has blocked their number by first dialing *67, or is calling from an area that does not support caller ID) to speak their name, which is recorded and then played back to the called party before the telephone call is established. The called party then has the option of accepting or rejecting the call before it is connected (so if the call is not completed, the calling party is purposely left not knowing whether the called party rejected the call, or was not available to take the call). Such a service: requires the caller to quickly figure out how to announce themselves, requires such callers to announce themselves each time they call, still disturbs the called party for every call by ringing their telephone even for calls from undesired callers and to wrong numbers, involves a more complicated and lengthy process for the called party to accept calls, requires the called party to go to the phone to listen to the caller's announcement even though the call may not be for them, and requires the called party to listen to the caller's recorded announcement even from undesired callers.

Furthermore, each of these telephone company services described above typically cost a few dollars each and every month. And if the subscriber has more than one telephone line, the services may be required for each telephone line, further increasing the monthly cost. Finally, if the subscriber moves, then all services would need to be reprogrammed at the new location.

Clearly, there is a need to provide a call classification and screening device which overcomes the limitations, restrictions and high costs of the prior art systems.

Throughout this specification, the term “telephone company” equally refers to any telephone network provider, cellular telephone operator or other communications service provider which offers communications services between calling and called parties. Such services may be utilize traditional copper cabling, or local network access based on community antenna television (CATV) cabling, fixed wireless (such as local multipoint distribution service—LMDS), powerline carrier or other technology. Networks supporting such communications services may be traditional telephone networks, packet data networks such as the public Internet, combinations of these, or other types of networks, such as private data networks. Further, “calling parties” and “called parties” equally refers to individuals, groups of individuals, computer-based and other systems, devices, or other equipment which utilize communications, and can be reached at a called location. This includes both one-to-one (one caller, one called party), and one-to-many (one caller, many called parties) communications, so this method could be used to determine which of many called devices sharing a telephone number or network address (such as a plurality of data gathering units) accept an incoming call.

### BRIEF SUMMARY OF THE INVENTION

An object of the present invention is to enable one called party to identify, as well as a plurality of potentially called parties at one location to simultaneously identify, specific telephone callers or categories of callers before the telephone is answered.

It is another object of the invention to utilize distinctive sounds so that called parties do not need to look at, be near, use their eyes or hands, nor go to the invention in order to identify the calling party. This is a benefit for handicapped and illiterate users, as well as the general public (for example, when the phone rings in the middle of the night).

It is another object of the invention that such distinctive sounds be selected so they are easy to mentally associate with specific callers and categories of callers. Specifically, rather than the traditional rings, electronic tone reproductions of rings, ringing cadences, and beeps used by standard telephones and cellular telephones, sounds with which the called party can quickly associate to particular callers are used—for example, a friendly dog barking for friends, a motorcycle accelerating for a business partner, and so on. Specifically, the distinctive sounds used are those made by animals, birds and other living things, automobiles, airplanes and other motorized vehicles, office equipment, musical instruments and other man-made devices, and electronically-produced sound effects.

It is another object of the invention that the distinctive sounds typically be assigned to specific callers or categories of callers after each caller calls, so that caller's directory numbers do not need to be manually entered (that is, the directory number from the most recently received caller ID message is used). The programming of the invention is therefore incremental, using two, or as little as a single button push, facilitating its adoption and integration into one's daily routine—though other methods, such as entering the callers' directory numbers from a numeric keypad or personal computer are also disclosed.

It is another object of the invention that each specific distinctive sound can be assigned to:

a single directory number—so that a single distinctive sound indicates a call from that single directory number, and;

a plurality of directory numbers—so that one distinctive sound can indicate a call from a specific caller that calls from several locations (perhaps their office, cellular telephone or home), or that one distinctive sound can indicate a call from a category of callers (such as all members of one's family).

For example, for a specific caller such as a business partner calling from either of their two phone lines, the invention could produce the sound of a motorcycle accelerating. And for telephone calls from any of one's personal friends the invention could produce the sound of a friendly dog barking.

It is another object of the invention to generate distinctive sounds so they can augment, but will preferably be used to replace, the ringing sounds produced by standard telephones. That is, the selected distinctive sound will be generated during the pause time between the power ring signals from the telephone company (so that the distinctive sounds can be heard even if the standard telephone ringers at the called party's location are not turned off), and in the preferred implementation, the distinctive sounds will be immediately terminated when the called party answers the call.

It is another object of the invention to be able to assign a distinctive sound to be generated for all calls from directory numbers which have not been assigned a specific distinctive sound (these are here called unrecognized callers).

It is another object of the invention to be able to assign a distinctive sound to be generated for telephone calls where the caller ID message from the telephone company does not include a directory number, but may instead include a reason code why no number is being forwarded (these are here called unavailable number calls). Such reason codes are typically a “B”, for blocked call (where the caller pressed *67 before dialing, so the telephone company does not forward the caller's directory number), an “O”, for out-of-area (where the call originated from a telephone company central office, private branch exchange (PBX) or analog cellular telephone which does not support caller ID), or a “P”, for private (where the caller has requested the telephone company to not forward their directory number).

It is another object of the invention to provide call classification and screening, by having “No Sound” available as one of the choices for the distinctive sounds which can be assigned to specific callers or categories of callers. For example, by programming the No Sound distinctive sound for unrecognized callers or unavailable number calls (these are collectively here called unknown number calls), the called party will not be disturbed by telemarketers, calls intended for fax machines or wrong numbers.

It is a another object of the invention to detect repeat unknown number calls, and to be able to assign a distinctive sound to be generated for such calls (the definition of repeat calls is presented below). While it is expected that detecting repeat unknown calls and assigning a different distinctive sound to those is most useful, detecting repeat recognized calls and assigning a different distinctive sound to these calls is also within the scope of the invention.

It is another object of the invention that when implemented as, or as part of, a device at a called party's location, that it optionally be able to duplicate its programming to other devices at the called party's location. This facilitates having multiple units in a household (for example), so the distinctive sounds can be heard throughout the household. The duplication of the programming information could be through dual-tone multifrequency (DTMF) or modem signals over the existing telephone cabling, through radio frequency (RF) or powerline carrier data transmission between units, direct connection of the units to each other or to a personal computer (PC), or other method.

It is another object of the invention that when implemented as, or as part of, a device at a called party's location, that the invention can be programmed (that is, the assignments made for the distinctive sounds and other options) through one or more of a variety of methods, such as using a keypad on the device, by communicating with the device using dual-tone multi-frequency tones from a telephone or using a personal computer, or copying the programming from another device.

It is another object of the invention that it connect to a standard telephone company modular jack as any other telephone or answering machine would, and that it not require any special wiring or installation procedure. And also that the invention be compatible with all other customer premises telephone equipment such as standard wired or cordless telephone sets, answering machines, facsimile machines and computer modems. However installing the invention in series between the incoming telephone line and the telephones would allow additional features, such as control of those telephone's ringers—at the expense of a more difficult installation: such an option is still considered within the scope of the invention.

It is another object of the invention that it can be implemented for all of the following situations:

for analog telephone network connections, for both;

on-hook caller ID messages, which are sent between the first and second power ring signals—and before the called party answers the telephone, and

off-hook caller ID messages, which are variously called spontaneous caller identification with call waiting, spontaneous call waiting identification (SCWID), visible call waiting, or caller identity delivery on call waiting (CIDCW)—a method of receiving this information is described in U.S. Pat. No. 5,263,084 to Chaput et al.—and are sent by the telephone company when a third party initiates a telephone call during an existing telephone call between the called party and a second party;

for digital (ISDN or other) telephone network connections, where the caller ID information is sent as digital signalling;

for traditional telephone company local access over twisted pair copper cabling, as well as other access methods including cable TV (community antenna television—CATV) infrastructure, fixed or mobile wireless radio, powerline carrier or other means;

for residential or business use;

for both traditional circuit switched telephone networks, as well as other networks, such as packet data networks including those using the transmission control protocol/internet protocol (TCP/IP) such as the public Internet;

as a stand-alone adjunct box at a called party's location, supporting both a single, as well as multiple telephone lines (in the latter case, LEDS or other means could indicate on which line the call has arrived);

utilizing distinctive sounds which may be stored and generated within a stand-alone adjunct box at a called location, distinctive sounds which may be stored within common equipment operated by the communications network provider and which are sent to the called location in real-time as needed, or distinctive sounds which may be stored and generated within a stand-alone adjunct box at a called location but downloaded from common equipment operated by the communications network provider, or other source, in advance, to allow a wider choice of distinctive sounds to be available;

as functionality built-in to a cordless or wired telephone, answering machine, facsimile machine, speakerphone, personal computer (PC), private branch exchange (PBX) or other equipment at a called party's location;

as functionality built-in to telephone network switching systems; and

as functionality built-in to digital or analog cellular or other public or private, terrestrial or satellite based wireless telephone handsets or network switching systems.

It is an object of this invention that it only require number-only caller ID service from the telephone company, where this service includes one or both of: on-hook and off-hook caller ID service (that is, the caller ID message is delivered while the called party is not, or is, engaged in a telephone call, respectively), though other implementations would be possible, such as using only the name portion of a caller ID message. Furthermore, while not requiring other services, the invention's operation is compatible with (that is, will not be adversely affected by) other telephone company services, such as caller ID with name display, call answer (telephone company based answering machine), conference calling, and distinctive ringing cadences.

Further objects and advantages of my invention will become apparent from a consideration of the drawings and ensuring description below.

The present invention overcomes the deficiencies of prior art call screening systems by giving the called party an easily remembered method of identifying callers before the telephone call is answered, according to the caller's directory number, or other identifying information, as forwarded in the telephone company caller ID message, for example, and without having to go to the telephone or a display, nor be able to, or even need to, read a display. The identification is by the called party assigning directory numbers to distinctive sounds, such as a those made by different types of birds and animals, motorized vehicles, machines or other sound effects, and these are then generated by the invention for incoming calls, between the power ring signals from the telephone company (so the sounds can be heard in the presence of ringing of standard telephones). Such sounds are easier to mentally associate with specific callers than ring cadences, take less time and are easier to comprehend than synthesized speech (which produces spoken words from text), and require less programming and are less expensive to generate and take less time to comprehend than digitized speech (which requires the required speech to be spoken, digitized and stored). It has been shown that distinctive sounds result in a faster reaction time than spoken words, for example in the paper The Speed of Response to Synthesized Voice Messages, by Wheale, British Journal of Audiology, 1981 Aug; 15(3):205-12.

Telephone calls from callers whose directory numbers have not been assigned a particular distinctive sound (for example, first-time callers) are assigned a distinctive ring sound (which is the same for all such “unrecognized callers”).

Even with caller ID service, some calls (such as telephone calls from areas that do not support caller ID, calls from analog cellular telephones, or calls where the caller first dials *67) arrive without the caller's telephone number in the caller ID message. The invention allows such calls to also be assigned a distinctive ring sound (which is the same for all such “unavailable number” calls).

It is expected that once the invention has been programmed with the desired distinctive sounds, the ringers built-in to the called-party's telephones will be turned off (though this is not necessary)—most telephones have an easily-accessible switch to do this. One of the invention's available distinctive sounds is no sound at all, so the invention can be programmed so it does not generate any sound for calls from; selected specific callers, all unrecognized callers and/or all unavailable number calls. Thus the invention provides call screening, since the called party will not know the phone is ringing for such selected calls, and so will not be bothered by such calls.

It is expected that the most useful programming of the invention will be as follows:

to generate distinctive sounds for calls from most recognized callers;

to generate no sound for calls from a few recognized callers, such as telemarketing organizations; and

to generate no sound, or a particular distinctive sound, for calls from unrecognized callers and also for unavailable number calls (these are collectively here called “unknown callers”).

Even for telephone calls where the invention has been programmed to generate no sound, if the called party has an answering machine (or subscribes to the similar service from their telephone company), the answering machine will still receive the power ring signals from the telephone company, so the answering machine will still answer telephone calls from unknown callers for which the invention generates no sound, and the answering machine can offer to record a message from the caller. So if desired, such callers can still leave a message on the called party's standard answering machine.

Finally, and most importantly, the invention can be programmed to assign a distinctive sound to repeat unknown calls—where such calls are from unknown callers, but the calls arrive with specific timing characteristics described below. So according to the most useful programming suggested above, calls from unknown callers will be ignored (since they generate no sound) the first time they call, but those callers will either know (perhaps from a previous conversation with the called party) that they should call back, or could learn this from the called party's answering machine greeting, which could be a message such as “Hello, this is Mitchell Shnier at 416 555-1212, please leave a message at the tone, or if you really need to speak to me please call back within one minute and I'll try to get to the phone.” The following subsequent situations are then likely:

If the call was in fact a wrong number, and was, for example;

from a fax broadcasting service and intended for a facsimile machine, then the caller or automatic dialer will realize from the answering machine greeting that there is no available receiving facsimile machine,

a person simply dialing the wrong number, then caller will determine this from the answering machine's greeting,

and the called party will not have been bothered by it, thus benefitting from the invention.

If the call was from an outbound telemarketing organization using predictive dialing computers (where telephone calls are automatically dialed faster than their personnel can handle them, in anticipation of the large percentage of busy and ring-no-answer calls, and calls answered by answering machines), then the telemarketing organization won't call back—either because such dialers recognize answering-machine-like greetings (U.S. Pat. No. 4,201,896 to Bower et al. and U.S. Pat. No. 5,371,787 to Hamilton, for example) and go on to the next call, or because the personnel don't have the time or control to call back. And again, the called party won't be bothered by the call, again benefitting from the invention.

If the caller does wish to directly speak to the called party, then the caller will place one or more subsequent calls to the called party, according to the timing directions provided by the answering machine greeting or by the called party during a previous conversation. The called party will then hear the distinctive sound assigned to repeat unknown callers, and can decide whether to answer the call.

### BRIEF DESCRIPTION OF THE DRAWINGS

FIG. 1 is a block diagram of the invention, and also shows that the invention is connected to a standard wall jack as any standard telephone or answering machine (for example) is, and is electrically connected in parallel with them.

FIG. 2A shows a front view of possible enclosure for the invention, when implemented as a stand-alone adjunct box to be located at a called party's premises. There is a row of four light emitting diode (LED) indicators along the top, and a matrix of 12 keypad buttons below them.

FIG. 2B is a left side view, and shows the two modular jacks for connection to the telephone line. Both are electrically connected in parallel, to facilitate sharing a single wall jack between both the invention and a telephone (for example). The power jack is also shown on the left side.

FIG. 3 shows a flow chart of the microcontroller program logic for handling incoming caller ID messages.

FIG. 4 shows a flow chart of the microcontroller program logic for handling keypad button presses for programming the invention.

FIG. 5 shows a timing diagram of an incoming telephone call, including the ringing, reception of the on-hook caller ID information, distinctive sound generated by the invention, and the called party's telephone going off-hook (that is, somebody answering the call).

### DETAILED DESCRIPTION OF THE INVENTION

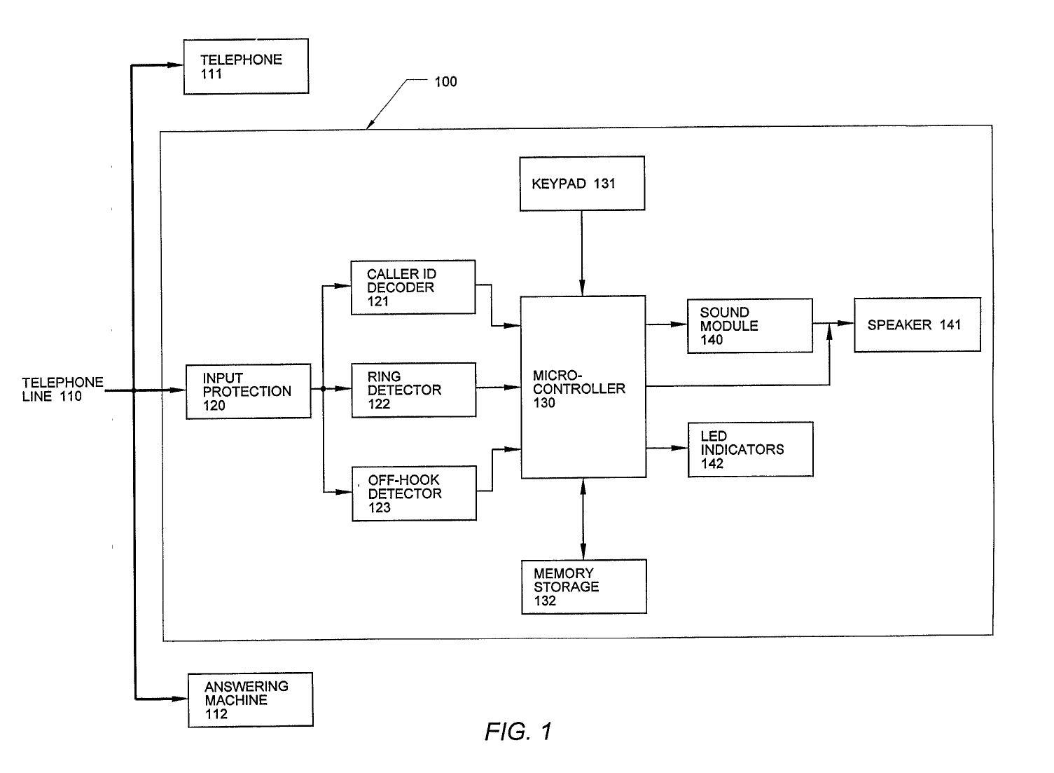

FIG. 1 shows an embodiment of the invention as a stand-alone adjunct box located at the called party's premises, though other implementations, such as functionality in a telephone set, answering machine, PBX or telephone company network switching system is also within the scope of the invention here described.

Referring to FIG. 1, the invention 100 is connected to a standard telephone company telephone line 110, in parallel with other telephony devices, such as a standard telephone 111 and answering machine 112.

The telephone line 110, typically from a telephone company central office first is connected to over-voltage input protection 120, such as that provided by a metal oxide varistor or other method widely accepted in the industry. The input then goes to three sub-circuits: a caller ID message decoder 121, a power ring signal detector 122 and an off-hook detector 123. Note that the entire invention would typically be powered by a wall-mount power transformer and a voltage regulator, both not shown for brevity as these are widely understood in the industry. The power supply could include battery back-up capability, to provide operation during power failures.

The invention is controlled by a microcontroller 130, such as a Microchip PIC 16C64.

The caller ID message decoder 121 and ring detector 122 sub-circuits may both be implemented in a single integrated circuit, such as the Motorola MC14LC5447. Also, the caller ID message decoding could be done by the microcontroller 130. The off-hook detector could be an H11AA opto-isolator.

The ring detector 122 alerts the microcontroller 130 that a caller ID message may be arriving shortly, and also provides the timing for the generation of distinctive sounds (both described further below). The caller ID message decoder 121 has the modem and filter circuits necessary to receive the caller ID message as sent from the telephone company, and converts the message to serial binary format which can be further processed by the microcontroller 130.

The format and method used for on-hook caller ID message transmission over analog local loops is described in the article Caller ID Fundamentals, by Richard Newman, Circuit Cellar Ink Magazine, April 1996, pages 18 to 20. While the caller ID message can have many components—such as the date and time of the call, and the name of the caller—the microcontroller program logic only utilizes the caller's directory number and the reason code for no directory number components.

A method for receiving off-hook caller ID information on analog local loops is described in U.S. Pat. No. 5,263,084 to Chaput et al. This service is variously called spontaneous caller identification with call waiting, spontaneous call waiting identification (SCWID), visible call waiting, or caller identity delivery on call waiting (CIDCW) by telephone companies, and is used to identify a third party when the third party initiates a telephone call during an existing telephone call between the called party and a second party.

While it is expected that the invention will be most useful utilizing on-hook caller ID message reception, a useful extension would be to also receive such off-hook caller ID messages, and utilizing this capability is included in the scope of the present invention.

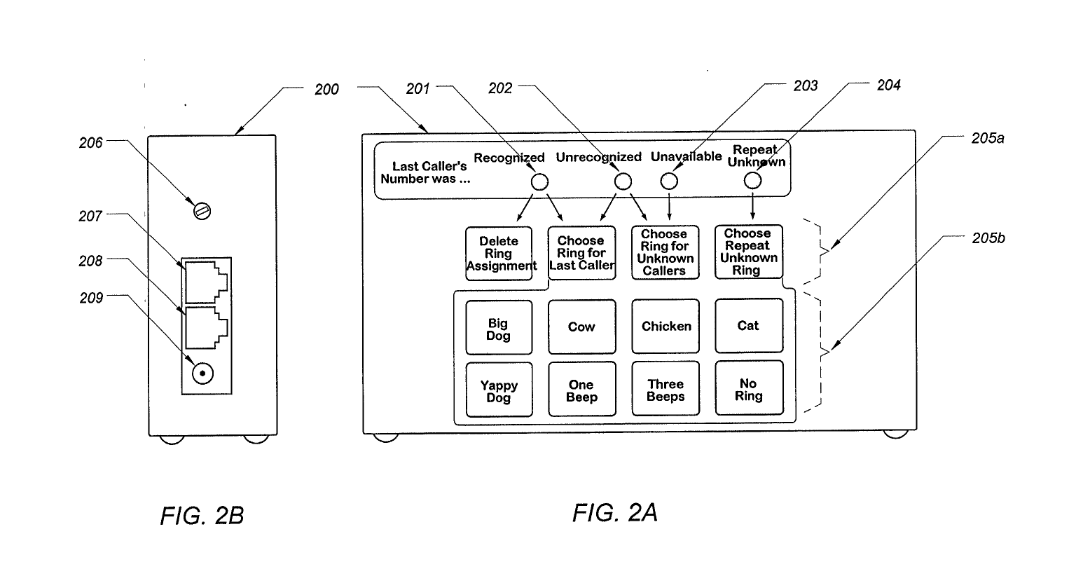

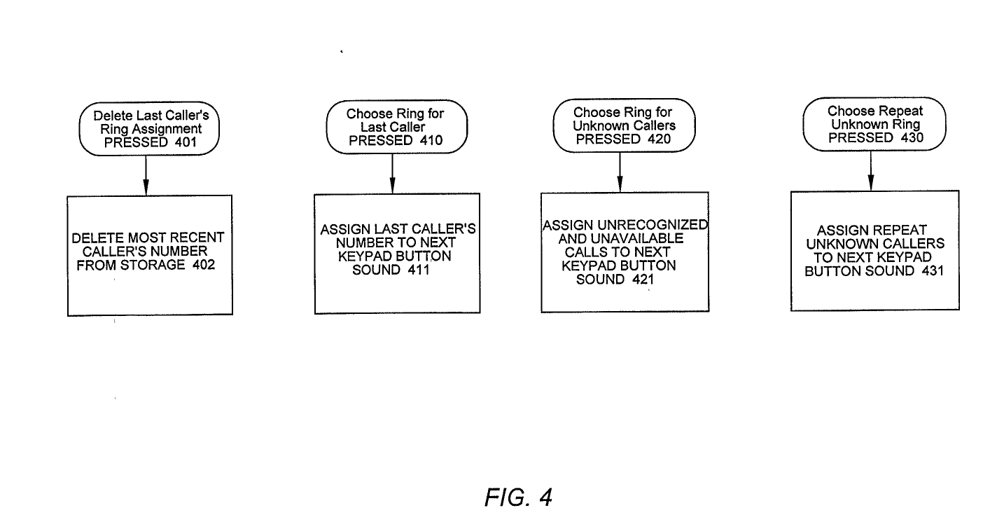

Received caller ID information is processed by the microcontroller 130 according to previous caller ID information received and programming information entered on keypad 131. The keypad 131 layout is shown in detail in FIG. 2A (205a and 205b), and its operation is shown in FIG. 4. The LEDS 142 are shown in detail in FIG. 2A (201, 202, 203 and 204). The operation of these are further described below.

Programming information is stored in non-volatile memory storage 132, which could be a Microchip 93LC66A—this device has the capacity to store distinctive sound assignments for about 84 recognized callers plus the distinctive sound assignments for unknown callers and repeat unknown callers. Other memory storage devices could store assignments for more callers if necessary.

Simple distinctive sounds, such as beeps are generated directly by microcontroller 130 through speaker 141. Animal and other more complex distinctive sounds could be generated by a sound module 140, such as that provided with kit SG10 from Daiwa Semitron, or could be generated directly by the microcontroller 130, possibly using digitized sounds stored in a separate or larger memory storage 132, or stored in the microcontroller's 130 internal program memory storage. LED indicators 142 provide indication that: caller ID information is being received (all LEDS illuminate), whether a directory number was received and if so, whether it was recognized (that is, has a distinctive ring assigned to it or not—resulting in the “Recognized” 201 or “Unrecognized” 202 LEDS, respectively, illuminating). Otherwise, the LEDS show whether the caller ID information had a reason code (“Unavailable” LED 203) instead of a caller's directory number, and whether this unknown caller's call is considered a repeat call, and if so, the “Repeat Unknown” LED 204 is also illuminated.

FIG. 2A shows the front view of a possible enclosure and keypad for the invention 200. The back of the invention, not shown, would typically have a grille for the speaker 141. Programming the invention involves one or two keypad button presses either anytime, or after a call has been received. This programming is described for FIG. 4 below. The keypad is comprised of four function buttons 205a and eight distinctive sound buttons 205b.

FIG. 2B shows volume control 206 for the distinctive sound volume. Modular jacks 207 and 208 are connected internally in parallel, and either jack can be used to connect to the telephone line 110, and the other jack to a telephone 111 or answering machine 112 (for example). Power connector 209 is to be connected to a wall-mount power transformer, not shown.

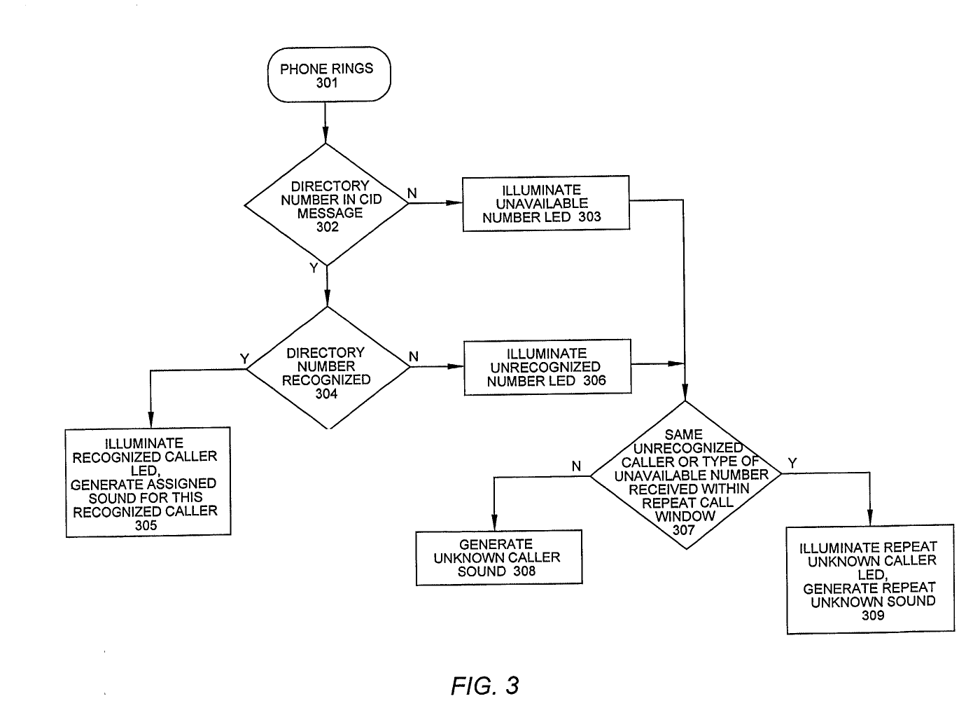

FIG. 3 shows the logic of handling caller ID messages, which for on-hook caller ID messages, always arrive beginning approximately ½-second after the end of the first power ring signal for that telephone call 301. If the caller ID message has a reason code instead of a caller's directory number 302, then the Unavailable number LED 203 is illuminated 303 and the logic continues to 307.

If the caller ID message does contain a directory number 302 then memory storage 132 is checked to see whether a distinctive sound assignment has been made for the directory number contained in the received caller ID message 304. If there is no assignment, then the Unrecognized number LED 202 is illuminated 306, and processing continues to 307.

At 307 a check is done to see if either a call from the same unrecognized directory number, or with the same reason code has been received previously, and whether this subsequent identical call (that is, the caller hung-up and called again) is to be considered a repeat call. Such repeat unknown calls here are defined as those where the first, or a subsequent, call, the total number of calls, or the time between any call attempts has specific counts and durations, such as with one or any combination of the following characteristics:

the first (or a subsequent) call is left to ring unanswered for a specific period (with some tolerance) of time—for example, for 4 (plus or minus 1) rings, or 24 (plus or minus 6) seconds—and then this call is terminated (the caller hangs-up) and the caller dials the same telephone number again;

the second (or a subsequent) call is made, or arrives, within a specific window of time after the previous call first arrived (first rang) or was terminated (the caller hung-up)—for example, the second call arrives within one minute after the first call arrived, or the second call arrives between two and three minutes after the first call stopped ringing; or

a specific or minimum number of calls are received (perhaps within a specific period of time), such as three telephone calls from the same directory number received within one minute.

When a call or subsequent call meets one or more (perhaps as programmed into the invention) of the conditions above 307, the invention illuminates the Repeat Unknown LED 204 and generates the assigned repeat unknown call distinctive sound 309. (Note that step 307 in FIG. 3 shows the single example of the second repeat call timing characteristic above, though any combination of timing characteristics could be required to satisfy step 307.) This enables unknown callers to “break through” the call screening to generate a different distinctive sound than that for first time unknown callers. This is a key feature of the invention.

While it is expected that the most desired embodiment of the invention would be to use the same distinctive sound for repeat unrecognized calls as for repeat unavailable number calls, the software could easily be changed to generate a different distinctive sound for these categories of calls, if so required. Another embodiment of the invention would be to use the same distinctive sound for all first-time calls—such as no sound at all—and a second distinctive sound for repeat calls—this would be useful, for example, as a temporary mode when the called does not wish to be disturbed unless the call is urgent, or so that wrong numbers or telemarketers will not disturb the called party, since these callers rarely call back, especially if the called party's answering machine greeting is reached due to the called party not answering the first call attempt.

If the call did not meet the conditions above 307, then no further LEDS are illuminated and the distinctive sound assigned to first-time (that is, non-repeat) unknown callers is generated 308.

If the caller's directory number is recognized (that is, has been assigned a distinctive sound) 304, then the Recognized number LED 201 is illuminated and the distinctive sound assigned to that directory number is generated 305. While it is expected that the most desired embodiment of the invention would be to generate the same assigned distinctive sound for both first-time recognized and repeat recognized calls, this could easily be changed to generate a different distinctive sound for such repeat recognized calls if so required.

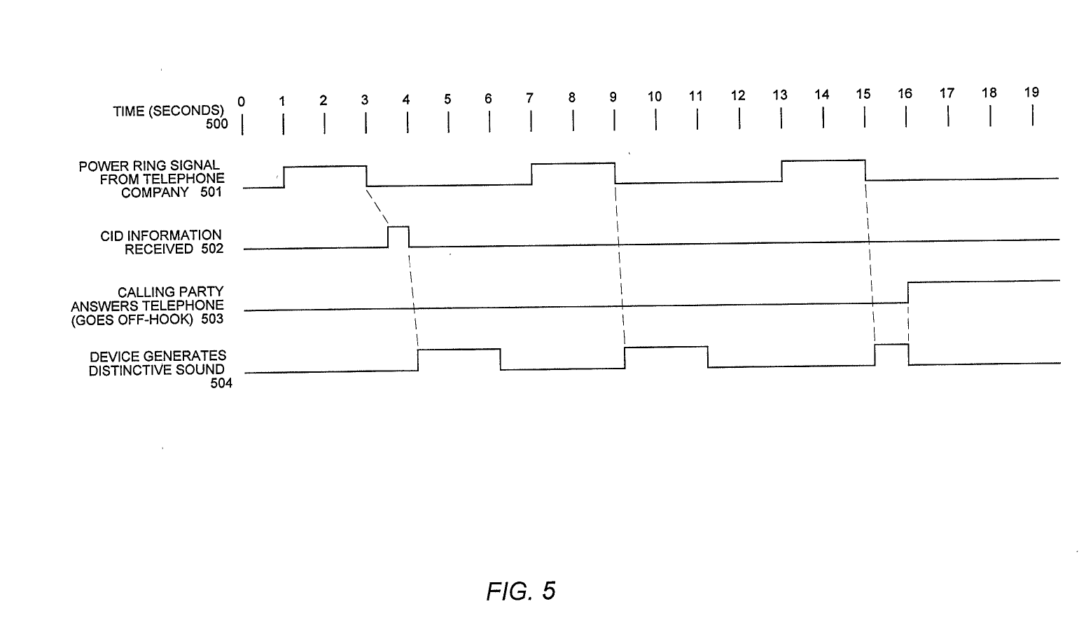

For all distinctive sounds generated by the invention, the logic is as shown in FIG. 5, described below.

FIG. 4 shows suggested logic for handling keypad 131 button presses to program the invention. This programming information is stored in non-volatile memory storage 132 by microcontroller 130, so remains in effect even if power to the invention is removed and restored.

Referring to FIG. 4, when the Delete Ring Assignment keypad button is pressed 401, the distinctive sound assignment stored for the last caller's directory number is deleted 402 from memory storage 132. This results in future calls from that directory number producing the distinctive sound assigned to unrecognized calls, and frees-up memory storage space for new assignments.

When the Choose Ring for Last Caller keypad button is pressed 410 the invention waits a period of time (10 seconds, for example) for a distinctive sound keypad button 205b to be pressed. If a distinctive sound keypad button 205b is pressed within that time, then that distinctive sound is assigned to the directory number which was received in the most recent caller ID message 411. This assignment is stored in memory storage 132. If the memory storage 132 is found to be full, then the oldest entry is overwritten. If it is found that there is already an entry for that directory number in the memory storage 132, then the distinctive sound assigned to that directory number is updated, without using an additional memory storage 132 assignment.

Note that the same distinctive sound can be assigned to a plurality of directory numbers. This permits the invention to generate the same distinctive sound for each call from a caller that calls from a more than one directory number (for example, from their office, home and cellular telephone, or from an office that has many outgoing telephone lines, each with their own directory number). It also permits many callers to share the same distinctive sound so, for example, the invention generates the same distinctive sound for all members of one's family, even though they each call from their own homes, businesses and cellular telephones.

When the Choose Ring for Unknown Callers keypad button is pressed 420 the invention waits a period of time (10 seconds, for example) for a distinctive sound keypad button 205b to be pressed. That distinctive sound is then assigned to be generated by the invention for both all calls from unrecognized directory numbers (that is, those which are not in memory storage 132, and therefore have no assignment) and all unavailable number calls (that is, those with a reason code instead of a directory number in the caller ID message) 421.

When the Choose Repeat Unknown Ring keypad button is pressed 430 the invention waits a period of time (10 seconds, for example) for a distinctive sound keypad button 205b to be pressed. That distinctive sound is then assigned to be generated by the invention for repeat unknown calls 431, which are telephone calls where the second (or subsequent) calls arrive with the timing and count characteristics described above.

If any distinctive sound keypad button 205b is pressed when a function keypad button 205a has not been pressed recently (within the last 10 seconds, for example), then no programming changes will be made, but the distinctive sound assigned by that button will be generated, to familiarize the user with the sound and volume to be expected (this logic is not shown in FIG. 4 as it is not essential for the invention).

Note that one of the distinctive sound keypad buttons 205b available is No Ring, which means that the invention will not generate any sound for callers (such as undesired callers) or categories of callers (such as non-repeat unknown callers) assigned to the No Ring distinctive sound.

While not described above, there are several additions that could easily be made to the keypad and microcontroller programming logic by one skilled in the art, and so are included in the scope of the invention. Such additions include the following:

adding a keypad button to configure the invention to temporarily consider all non-repeat (that is, first time) callers to be assigned to the No Ring distinctive sound for a specific period of time, or a scheduled periodic interval of time (such as each night) or until a further keypad button press, as this would provide a “do not disturb unless urgent” feature for all calls;

adding a keypad button to configure the invention to temporarily assign unknown callers to a distinctive sound other than No Ring for a specific period of time, a scheduled period of time (such as each business day), or until a further button press, so that the invention would generate a distinctive sound for expected calls from callers who have never called before (for example, you just left your telephone number in a voice-mail message for someone to call you back, and you do not yet know the directory number from which they will call back);

a keypad sequence to reassign all callers assigned to one distinctive sound to another distinctive sound;

adding a numeric keypad to enable caller's directory numbers to be added directly, without requiring them to call first—so the invention could be programmed before installing it or before specific expected callers first call;

implementing the invention as part of an answering machine, voice-mail system or other device that can output digitized or synthesized speech to callers so that a different greeting could be used for specific callers or categories of callers—this would permit (for example) unknown callers to be prompted to call back according to the repeat caller timing, but recognized callers would be prompted to simply leave a message;

a capability of programming the invention through an additional connector, not shown, as this would (for example) enable the programming information to be copied from one unit to another (to facilitate installing a plurality of units programmed identically), and for the invention's programming to be examined, backed-up, changed and/or created from a personal computer or other device;

a capability of programming the invention remotely, using signalling over the telephone or other network connection, such as dual-tone multifrequency (DTMF) tones, analog modem modulation from a remote unit or computer, or using digital signalling techniques over a digital network such as through the D channel of an ISDN network or as a control message in a TCP/IP network (such as the public Internet); and

a capability of copying programming from one unit to another, over the existing telephone wiring in a household (for example), between units, either manually initiated, or automatically after programming changes are made, while the telephones are either off-hook or on-hook.

FIG. 5 shows the relative timing for the distinctive sounds generated by the invention as a result of receiving an on-hook caller ID message (that is, there is no telephone call in progress). Along the top 500 shows the elapsed time in seconds. This shows that, for example, the ring cadence 501 is ring for 2 seconds (from second 1 to 3), followed by silence for 4 seconds (from second 3 through 7), followed by ring for 2 seconds (from second 7 to 9), and so on—which is a typical ring cadence for telephones in North America. Waveform 502 shows that the caller ID message is typically delivered from the telephone company as a short data burst of about ½-second duration, beginning ½-second after the end of the first ring of a new telephone call (in FIG. 5, the end of the first ring is at second 3, and the caller ID message is received from second 3½ to 4). The invention then completes the logic shown in FIG. 3 and generates a distinctive sound, shown in waveform 504 as approximately two seconds in duration (from second 4 to 6), although it could be a longer or shorter duration as required by the specific sound. If the called party does not yet answer the telephone (that is, the called party's telephone is still on-hook), then the invention will generate a second distinctive sound (second 9 to 11) immediately after the end of the second power ring signal from the telephone company (which occurs at second 9).

The invention will continue to generate distinctive sounds immediately after each power ring signal from the telephone company (in FIG. 5, the end of the third power ring signal is at second 15, so the invention generates a third distinctive sound 504 starting at second 15) until the power ring signal from the telephone company stops. This may be because the calling party hangs-up, because the call was transferred to a telephone company provided voice-mail system (which they may refer to as Call Answer, Invisible Answering Machine)—because the call was not answered—or because the called party (or their answering machine, for example) answers the telephone call (that is, goes off-hook). Waveform 503 shows that the called party goes off-hook at second 16, which the invention detects through off-hook detector 123, and the ringing logic of the invention then immediately ceases generating the distinctive ring sound, as shown at second 16 of waveform 504.

For the case that the called party is already engaged in a telephone call (not shown), and the called party subscribes to the off-hook caller ID service from their telephone company (which may be called spontaneous caller identification with call waiting), then the invention could instead generate the distinctive sound after each call waiting indication beep sent to the called party, and the distinctive sounds would be so generated until the call waiting indication beeps stop, for example, either because the calling party hung-up or was transferred to a telephone company based answering machine service.

Therefore, what I claim as my invention is:

1. A sonic method of indicating the classification of a specific caller or category of caller that initiated a call over a communications network, such method comprising:
a) a means for receiving and decoding identifying information from said communications network, where said identifying information is selected from the group consisting of the caller's;
i) directory number, and
ii) name, and
iii) network address, and
iv) location, and
v) other information which can be generated as a result of said caller's call or connection being initiated;
b) a means for producing a plurality of distinctive sounds audible at the called location, the distinctive sounds available to be assigned are selected to facilitate the person or people at the called location being able to quickly mentally associate the distinctive sound to the specific caller or category of caller, said plurality of distinctive sounds selected from the group consisting of those produced by animals, birds and other living things, and motorized vehicles, office equipment, musical instruments and other man-made devices, and other electronically-produced sound effects;
c) providing an assignment store to hold a plurality of assignments of identifying information to the corresponding distinctive sound to be produced when said identifying information is received, assignments can also be stored for the distinctive sound to be produced for other specific situations, including when identifying information is received for which an assignment has not been made, and when a call is initiated but the required identifying information is not available from said communications network;
d) providing a means for creating said assignments;
e) providing logic means for comparing received identifying information with that in the assignment store, and;
i) if said assignment store has an assignment for the received identifying information, then the corresponding distinctive sound will be produced,
ii) if said assignment store does not have an assignment for the received identifying information, then the distinctive sound assigned for such unrecognized identifying information will be produced, and
iii) if the received identifying information is not sufficient to uniquely identify a caller or their category, then the distinctive sound assigned for calls where identifying information is not available will be produced,
whereby one or more people at a called location can simultaneously decide, without having to go to, or read a display, whether and in what manner to answer a call.

2. The method of claim 1, wherein said identifying information is contained in a message received in one of the following manners;
a) over an analog telephone network connection, when the called location does not have a call in progress at the time the identifying information is received, such identifying information is typically referred to as a caller ID message,
b) over an analog telephone network connection, when the called location has a call in progress at the time the identifying information is received, such identifying information is sometimes referred to as a spontaneous caller identification with call waiting message,
c) over digital networks, such identifying information being contained in an information element such as the origination address in a call establishment message
d) over networks based on the transmission control protocol/internet protocol, such identifying information being contained in a protocol data unit.

3. The method of claim 1, further including timing and counting means to categorize certain calls as repeat calls, for calls received which have timing and count characteristics selected from the group consisting of:
a) a caller initiates a call to a called location, and said call is left unanswered for a duration which is between a predetermined minimum and maximum period of time, at the end of said duration, said call is terminated by said caller, at which time said caller initiates a subsequent call to said called location, and
b) a caller initiates a call to a called location, and said call is left unanswered for a number of ring signals, which is between a predetermined minimum and maximum number of ring signals, at the end of said number of ring signals, said call is terminated by said caller, at which time said caller initiates a subsequent call to said called location, and
c) a caller initiates a call which arrives at a called location at a time which is between a predetermined minimum and maximum period of time after the arrival of a previous unanswered call from said caller to said called location, and
d) a caller initiates a call which arrives at a called location at a time which is between a predetermined minimum and maximum period of time after the termination of a previous unanswered call from said caller to said called location, and
e) a caller initiates a predetermined minimum quantity of calls to a single called location, optionally within a predetermined minimum and maximum period of time,
whereby said assignment store can hold an assignment for the distinctive sound to be produced upon the receipt of said repeat calls which have said timing and count characteristics,
whereby one or more people at a called location can simultaneously decide, without having to go to, or read a display, whether and in what manner to answer said repeat calls.

4. The method of claim 1, wherein said distinctive sounds may be produced by a method selected from the group consisting of:
a) said distinctive sounds are permanently stored in, and generated by, equipment at the called location, and
b) said distinctive sounds are sent to the called location in real-time as said distinctive sounds are to be produced at the called location, and
c) said distinctive sounds are transferred in advance from said communications network, or other source, to equipment at the called location to permit said distinctive sounds to then be generated locally at the called location as required while allowing a wide selection of distinctive sounds to be available.

5. The method of claim 1 or 3, wherein the distinctive sound assigned to specific callers or categories of callers can also be no sound, such assignment being useful so that calls from said specific callers or categories of callers do not disturb people at the called location.

6. The method of claim 1 or 3, wherein the distinctive sound is produced with characteristics selected from the group consisting of:
a) said distinctive sound is produced instead of the standard audible incoming call alerting ring sound, and
b) said distinctive sound is produced during the pause time between the power ring signals on an analog telephone network,
whereby said distinctive sound can easily be heard by people at the called location without needing to disable the ringers in the telephones at the called location.

7. An apparatus for audibly indicating the classification of a specific caller or category of caller that initiated a call over a communications network, comprising:
a) a circuit for receiving and decoding identifying information from said communications network, where said identifying information is selected from the group consisting of the caller's;
i) directory number, and
ii) name, and
iii) network address, and
iv) location, and
v) other information which can be generated as a result of said caller's call or connection being initiated;
b) a circuit for generating a plurality of distinctive sounds audible at the called location, the distinctive sounds available to be assigned are selected to facilitate the person or people at the called location being able to quickly mentally associate the distinctive sound to the specific caller or category of caller, said plurality of distinctive sounds selected from the group consisting of those produced by animals, birds and other living things, and motorized vehicles, office equipment, musical instruments and other man-made devices, and other electronically-produced sound effects;
c) an assignment store to hold a plurality of assignments of identifying information to the corresponding distinctive sound to be produced when said identifying information is received, assignments can also be stored for the distinctive sound to be produced for other specific situations, including when identifying information is received for which an assignment has not been made, and when a call is initiated and the required identifying information is not available from said communications network;
d) means for creating said assignments;
e) logic means for comparing received identifying information with that in the assignment store, and;
i) if said assignment store has an assignment for the received identifying information, then the corresponding distinctive sound will be produced;
ii) if said assignment store does not have an assignment for the received identifying information, then the distinctive sound assigned for such unrecognized identifying information will be produced; and
iii) if the received identifying information is not sufficient to uniquely identify a caller or their category, then the distinctive sound assigned for calls where identifying information is not available will be produced,
whereby one or more people at a called location can simultaneously decide, without having to go to, or read a display, whether and in what manner to answer a call.

8. The apparatus in claim 7, embodied as a stand-alone adjunct device whose primary purpose is the audible classification of callers or categories of callers.

9. The apparatus in claim 7, further including components and logic to perform other functions, said other functions selected from the group consisting of;
a) a wired or cordless telephone, and
b) an answering machine, and
c) a modem, and
d) a facsimile machine, and
e) a computer, and
f) a device providing voice communications services, and
g) a device providing other types of communication services at a called location,
whereby the resulting integrated communications device advantageously shares subsystems such as power supply and keypad,
whereby said audible classification of callers and categories of callers is part of the total functionality of said integrated communications device.

10. The apparatus of claim 7, wherein the information in said assignment store can be transferred between similar devices to ensure they can each have the same information in their respective assignment stores, as well as to other devices such as personal computers, for the purposes of having a back-up copy of the assignment store information and possibly allowing more convenient editing of said information in said assignment store.

11. The apparatus in claim 7, wherein said communications network is selected from the group consisting of:
a) the public switched telephone network, with both analog and digital interfaces to it, and
b) the public Internet, with both analog and digital interfaces to it, as well as, digital subscriber line, community antenna television infrastructure, optical fiber, powerline carrier, local multipoint distribution service and satellite communications interfaces
c) other networks, such as those using protocols based on the transmission control protocol/internet protocol
whereby the identifying information is sent using the means appropriate to said communications network.

12. The apparatus in claim 7, wherein certain constituent components and functions, such as the assignment store and logic means for comparing received identifying information, are located in common equipment within the communications network rather than at said called location, whereby the sonic indication of the classification of a specific caller or category of caller can be a service offered by the communications network provider.

13. The apparatus of claim 7, further including logic means for timing and counting to categorize certain calls as repeat calls, for calls received which have timing and count characteristics selected from the group consisting of:
a) a caller initiates a call to a called location, and said call is left unanswered for a duration which is between a predetermined minimum and maximum period of time, at the end of said duration, said call is terminated by said caller, at which time said caller initiates a subsequent call to said called location, and
b) a caller initiates a call to a called location, and said call is left unanswered for a number of ring signals, which is between a predetermined minimum and maximum number of rings, at the end of said number of ring signals, said call is terminated by said caller, at which time said caller initiates a subsequent call to said called location, and
c) a caller initiates a call which arrives at a called location at a time which is between a predetermined minimum and maximum period of time after the arrival of a previous unanswered call from said caller to said called location, and
d) a caller initiates a call which arrives at a called location at a time which is between a predetermined minimum and maximum period of time after the termination of a previous unanswered call from said caller to said called location, and
e) a caller initiates a predetermined minimum quantity of calls to a single called location, optionally within a predetermined minimum and maximum period of time,
whereby said assignment store can hold an assignment for the distinctive sound to be produced upon the receipt of said repeat calls which have said timing and count characteristics,
whereby one or more people at a called location can simultaneously decide, without having to go to, or read a display, whether and in what manner to answer a call.

14. The apparatus of claim 7, wherein said distinctive sounds may be produced by a method selected from the group consisting of:
a) said distinctive sounds are permanently stored in, and generated by, equipment at the called location, and
b) said distinctive sounds are sent to the called location in real-time as said distinctive sounds are to be produced at the called location, and
c) said distinctive sounds are transferred in advance from said communications network to equipment at the called location to permit said distinctive sounds to then be generated locally at the called location as required while allowing a wide selection of distinctive sounds to be available.

15. The apparatus of claim 7 or 13, wherein the distinctive sound assigned to specific callers or categories of callers can also be no sound, such assignment being useful so that calls from said specific callers or categories of callers do not disturb people at the called location.

16. The apparatus of claim 7 or 13, wherein the distinctive sound is produced with characteristics selected from the group consisting of:
a) said distinctive sound is produced instead of the standard audible incoming call alerting ring sound, and
b) said distinctive sound is produced during the pause time between the power ring signals on an analog telephone network,
whereby said distinctive sound can easily be heard by people at the called location without needing to disable the ringers in the telephones at the called location.
